(19) United States
(12) Patent Application Publication
(10) Pub. No.: US 2006/0263506 A1
(43) Pub. Date: Nov. 23, 2006

(54) Low carbohydrate pudding

(76) Inventor: Christopher J. Scinto, Palmdale, CA (US)

Correspondence Address: LOWE HAUPTMAN BERNER, LLP, 1700 DIAGONAL ROAD, SUITE 300, ALEXANDRIA, VA, 22314, US

(21) Appl. No.: 11/133,320

(22) Filed: May 20, 2005

(51) Int. Cl. A23L 1/05

(52) U.S. Cl. 426/575

(57) ABSTRACT

A low carbohydrate low fat ready-to-eat pudding includes water and a combination of carrageenan and other proteins such as calcium caseinate and/or sodium caseinate and soy protein isolate. It may also include whey proteins, soybean oil, sodium chloride, potassium chloride, dipotassium phosphate, flavoring, cocoa tricalcium phosphate, sucralose powder and acesulfame potassium. However, the pudding is free of starch, hydrogenated oils and trans fatty acids.

This invention relates to a ready to eat low carbohydrate pudding and more particularly to a ready to eat low carbohydrate pudding that meets the guidelines for a low-fat food.

### BACKGROUND OF THE INVENTION

Ready to eat puddings are well known. For example, a U.S. patent of O'Rourke U.S. Pat. No. 4,215,152 discloses a pre-gelatinized starch product for use in instant pudding. The pudding is prepared by drum drying a slurry containing an ungelatinized starch in water with a protein and an emulsifier. As disclosed therein the protein is sodium caseinate and the emulsifier is polysorbate.

High protein puddings are also well known. For example, a U.S. patent of Duren U.S. Pat. No. 3,689,288 discloses a high protein pudding which is made by forming an aqueous protein containing mixture and heating the mixture to a predetermined level to form a gel. The gel is then cooled while being subjected to mechanical working and subsequently placed in a can. The protein material may be vegetable protein isolate concentrate or curd with other well known ingredients such as sugar, non-fat dry milk and flavoring materials. This mixture is then formed into an aqueous mixture by adding water. As stated in the patent, water should constitute between 50% to 78% by weight of the mixture.

The majority of commercial puddings, whether ready-to-eat or dry mix use a combination of starch and specific chemical salts to create a product set. However, current nutritional diet guidelines call for low carbohydrates and high protein. Such guidelines also suggest avoiding ill health affects that have been associated with two much fat in a diet.

It is now believed that there may be a relatively large commercial market for an improved ready-to-eat low carbohydrate pudding according to the present invention. It is believed that there may be a large market because such puddings meet the guidelines for a low fat, low carbohydrate food while avoiding any ill effects that have been associated with too much fat in a diet.

Advantageously, puddings in accordance with the present invention meet the current nutritional guidelines for low carbohydrates and high proteins. However, unlike some current commercial low carbohydrate high protein products, puddings in accordance with the present invention meet the guidelines for a low fat food. In addition, the puddings disclosed herein have a relatively low amount of saturated fat and do not have any starches, hydrogenated oils or trans fatty acids. Further, the pudding formulas disclosed herein do not use “filler carbohydrates” such as glycerin or sugar alcohols that are subjectively deemed “low impact” that are commonly used in desserts.

Also, the puddings in accordance with the present invention provide enough soy protein in a 5.82 to 6.4 oz serving to make a claim for the reduction of certain types of cancer. The puddings are also low glycemic, thereby safe for diabetics and amylase resistant. Therefore, the formulas allow for multiple “eatings” out of the same carton without the product breaking down as occurs in starch based puddings.

A majority of commercial puddings, whether read-to-eat or dry mix, use a combination of starch and specific chemical salts to create the product set. However, the present invention uses a combination of carrageenan and proteins to make the product set. In addition, the use of carrageenan and proteins provides a quick set and one that is reversible. This reversible set feature results in a robust product under conditions of freeze/thaw and relatively high heat during distribution or other circumstances.

In addition, the heat stability of the pudding in accordance with this invention allows for the pudding to be processed under many different conditions. For example, the pudding composition can be retorted in suitable containers as well as aseptically processed and filled into cans or plastic containers to produce a shelf stable product. Further, the combination of setting ingredients allows for the mixture to be pasteurized and filled into cans or plastic containers to produce a product for refrigerated distribution without the need for a formula change as in starch based puddings.

### BRIEF SUMMARY OF THE INVENTION

In essence, the present invention contemplates a ready-to-eat low fat low carbohydrate pudding. The pudding contains water, calcium caseinate and/or sodium caseinate, soy protein isolate and soybean oil. The pudding also includes sodium chloride, carrageenan, dipotassium phosphate, flavorings, cocoa tricalcium phosphate, sucralose powder and acesulfame potassium. The pudding in accordance with the present invention includes between about 80% by weight to 90% by weight water and is free of hydrogenated oils, trans fatty acids, starch and other carbohydrates. However, such puddings may include small amounts of whey protein isolate, whey protein concentrate and potassium chloride.

In a preferred embodiment of the invention, the pudding includes from 0.1% to 0.35% by weight carrageenan and wherein the amount of carrageenan is inversely related to the amount of water. For example, the less water the more carrageenan and the more water the less carrageenan. Thus, for 80% water, the composition would include about 0.35% weight carrageenan and for 90% water about 0.1% carrageenan.

A pudding in accordance with a preferred embodiment of the invention includes the following ingredients in the following ranges as indicated in % by weight.

| | |
|---|---|
| 80-90 | Water |
| 5-9 | Calcium Caseinate and/or Sodium Caseinate |
| 4.5-7.5 | Soy Protein Isolate |
| 0-3.0 | Whey Protein Isolate |
| 0-1.5 | Whey Protein Concentrate |
| 0.5-1.75 | Soybean Oil |
| 0.1-0.5 | Sodium Chloride |
| 0-0.4 | Potassium Chloride |
| 0.1-0.35 | Carrageenan |
| 0.1-0.45 | Dipotassium Phosphate |
| 0.1-0.5 | Flavor |
| 0.025-0.3 | Tricalcium Phosphate |
| 0.03-0.05 | Sucralose Powder |
| 0.03-0.04 | Acesulfame Potassium |

### DESCRIPTION OF THE PREFERRED EMBODIMENTS OF THE INVENTION

A ready-to-eat low carbohydrate, low fat pudding in accordance with the present invention is free of hydrogenated oils, trans fatty acids and starch. Such puddings use a combination of carrageenan and various other proteins in preselected amounts to provide a quick set. Other ingredients included in the preferred formulation include water, calcium caseinate and/or sodium caseinate, soy protein isolate, whey protein isolate, whey protein concentrate, soybean oil, sodium chloride, potassium chloride, dipotassium phosphate, cocoa, flavor tricalcium phosphate, sucralose powder and acesulfame potassium.

The invention will now be described in connection with the following examples which may be prepared by the following process. All percentages shown are % by weight.

The dry ingredients may be mixed in a sigma mixer or other commercial mixer of the type commonly used in the commercial production of puddings. In the alternative, the dry ingredients and hot water at about 150° F. may be mixed in an industrial blender for sufficient time to obtain a uniform mix as will be well understood by persons or ordinary skill in the art. The uniform mix is then processed in an ultra high temperature processor at or between about 265° F. to about 295° F. to produce an aseptic product, cooled and filled in cans or plastic containers to provide a shelf stable product.

In the alternative, the homogenized mix can be retorted in cans or plastic containers. In addition, the combination of setting ingredients allows for the product formula to be pasteurized and filled in cans or plastic containers to provide a product for refrigerated distribution without any need for a change in formulation as in starch based puddings.

### Example I

High Protein Low Carbohydrate Chocolate Pudding

| | |
|---|---|
| Water | 80.0000%-90.0000% |
| Calcium Caseinate and/or | 5.000%-9.000% |
| Sodium Caseinate | |
| Soy Protein Isolate | 4.5000%-7.5000% |
| Whey Protein Isolate | 0.0000%-3.0000% |
| Whey Protein Concentrate | 0.0000%-1.5000% |
| Soybean Oil | 0.5000%-1.5000% |
| Sodium Chloride | 0.1%-0.5000% |
| Potassium Chloride | 0.0%-0.4% |
| Carrageenan | 0.1000%-0.35000% |
| DiPotassium Phosphate | 0.1000%-0.1500% |
| Cocoa | 1.75000%-2.7500% |
| TriCalcium Phosphate | 0.02500%-0.3% |
| Sucralose Powder | 0.03%-0.0500% |
| Acesulfame Potassium | 0.0300%-0.0400% |

### Example II

High Protein Low Carbohydrate Vanilla Pudding

| | |
|---|---|
| Water | 80.0000%-90.0000% |
| Calcium Caseinate | 6.0000%-9.0000% |
| Soy Protein Isolate | 4.5000%-7.5000% |
| Whey Protein Isolate | 0.0000%-3.0000% |
| Whey Protein Concentrate | 0.0000%-1.5000% |
| Soybean Oil | 0.7500%-1.7500% |
| Sodium Chloride | 0.1%-0.5000% |
| Potassium Chloride | 0.0%-0.4% |
| Carrageenan | 0.1000%-0.35000% |
| DiPotassium Phosphate | 0.3000%-0.4500% |
| Vanilla Flavor | 0.1000%-0.5000% |
| TriCalcium Phosphate | 0.0250%-0.3% |
| Sucralose Powder | 0.03%-0.0500% |
| Acesulfame Potassium | 0.0300%-0.0400% |

### Example III

High Protein Low Carbohydrate Vanilla Pudding

| | |
|---|---|
| Water | 80.0000%-90.0000% |
| Sodium Caseinate | 6.0000%-9.0000% |
| Soy Protein Isolate | 4.5000%-7.5000% |
| Whey Protein Isolate | 0.0000%-3.0000% |
| Whey Protein Concentrate | 0.0000%-1.5000% |
| Soybean Oil | 0.7500%-1.7500% |
| Sodium Chloride | 0.1%-0.5000% |
| Potassium Chloride | 0.0%-0.4% |
| Carrageenan | 0.1000%-0.35000% |
| DiPotassium Phosphate | 0.3000%-0.4500% |
| Vanilla Flavor | 0.1000%-0.5000% |
| TriCalcium Phosphate | 0.0250%-0.3% |
| Sucralose Powder | 0.03%-0.0500% |
| Acesulfame Potassium | 0.0300%-0.0400% |

### Example IV

High Protein Low Carbohydrate Butterscotch Pudding

| | |
|---|---|
| Water | 80.0000%-90.0000% |
| Calcium Caseinate | 6.0000%-9.0000% |
| Soy Protein Isolate | 4.5000%-7.5000% |
| Whey Protein Isolate | 0.0000%-3.0000% |
| Whey Protein Concentrate | 0.0000%-1.5000% |
| Soybean Oil | 0.7500%-1.7500% |
| Sodium Chloride | 0.1%-0.5000% |
| Potassium Chloride | 0.0%-0.4% |
| Carrageenan | 0.1000%-0.35000% |
| DiPotassium Phosphate | 0.3000%-0.4500% |
| Butterscotch Flavor | 0.1000%-0.5000% |
| TriCalcium Phosphate | 0.02500%-0.3% |
| Sucralose Powder | 0.03%-0.0500% |
| Acesulfame Potassium | 0.0300%-0.0400% |

### Example V

High Protein Low Carbohydrate Banana Pudding

| | |
|---|---|
| Water | 80.0000%-90.0000% |
| Calcium Caseinate | 6.0000%-9.0000% |
| Soy Protein Isolate | 4.5000%-7.50000% |
| Whey Protein Isolate | 0.0000%-3.0000% |
| Whey Protein Concentrate | 0.0000%-1.5000% |
| Soybean Oil | 0.7500%-1.7500% |
| Sodium Chloride | 0.1%-0.5000% |
| Potassium Chloride | 0.0%-0.4% |
| Carrageenan | 0.1000%-0.35000% |
| DiPotassium Phosphate | 0.3000%-0.4500% |
| Banana Flavor | 0.1000%-0.5000% |
| TriCalcium Phosphate | 0.02500%-0.3% |
| Sucralose Powder | 0.03%-0.0500% |
| Acesulfame Potassium | 0.0300%-0.0400% |

### Example VI

High Protein Low Carbohydrate Chocolate Pudding

| | |
|---|---|
| Water | 83.7776% |
| Calcium Caseinate | 6.8714% |
| Soy Protein Isolate | 5.5556% |
| Soybean Oil | 0.5848% |
| Sodium Chloride | 0.4386% |
| Carrageenan | 0.3250% |
| DiPotassium Phosphate | 0.1170% |
| Cocoa | 2.2132% |
| TriCalcium Phosphate | 0.0439% |
| Sucralose Powder | 0.0400% |
| Acesulfame Potassium | 0.0330% |

### Example VII

High Protein Low Carbohydrate Vanilla Pudding

| | |
|---|---|
| Water | 84.7029% |
| Calcium Caseinate | 7.4562% |
| Soy Protein Isolate | 5.5556% |
| Soybean Oil | 0.8772% |
| Sodium Chloride | 0.4386% |
| Carrageenan | 0.3000% |
| DiPotassium Phosphate | 0.3626% |
| Vanilla Flavor | 0.1900% |
| TriCalcium Phosphate | 0.0439% |
| Sucralose Powder | 0.0400% |
| Acesulfame Potassium | 0.0330% |

### Example VIII

High Protein Low Carbohydrate Pudding Prototype

Vanilla

| | |
|---|---|
| Water | 84.2878% |
| Calcium Caseinate | 7.697% |
| Soy Protein Isolate | 5.7576% |
| Soybean Oil | 0.9091% |
| Sodium Chloride | 0.4545% |
| Carrageenan | 0.2% |
| DiPotassium Phosphate | 0.3758% |
| Flavor | 0.197% |
| TriCalcium Phosphate | 0.0455% |
| Sucralose | 0.0415% |
| Acesulfame Potassium | 0.0342% |

### Example IX

High Protein Low Carbohydrate Pudding Prototype

Chocolate

| | |
|---|---|
| Water | 83.3667% |
| Calcium Caseinate | 7.0909% |
| Soy Protein Isolate | 5.7576% |
| Soybean Oil | 0.6061% |
| Sodium Chloride | 0.4545% |
| Carrageenan | 0.15% |
| DiPotassium Phosphate | 0.1212% |
| Cocoa | 2.3318% |
| TriCalcium Phosphate | 0.0455% |
| Sucralose | 0.0415% |
| Acesulfame Potassium | 0.0342% |

Sodium caseinate is used in the presently preferred embodiment of the invention, however small amounts of calcium caseinate may be included. Also in some applications, calcium caseinate is preferred.

While the invention has been described in connection with the preferred embodiments, it should be recognized that changes and modifications can be made therein without departing from the scope of the appended claims.

1. A ready-to-eat low carbohydrate pudding consisting essentially of water, calcium caseinate and/or sodium caseinate, soy protein isolate, soybean oil, sodium chloride, carrageenan, dipotassium phosphate, flavoring, cocoa tricalcium phosphate, sucralose powder, acesulfame potassium and wherein said pudding contains between 80 weight % and 90 weight % of water and is free of hydrogenated oils, trans fatty acids, starch and other carbohydrates.

2. A ready-to-eat low carbohydrate pudding according to claim 1 which includes up to 3.0% weight whey protein isolate, up to 1.5% by weight whey protein concentrate and up to 0.4% potassium chloride.

3. A ready-to-eat low carbohydrate pudding according to claim 2 which includes from 0.1 to 0.35% carrageenan and wherein the amount of carrageenan is inversely proportional to the amount of water so that when the water is 80 weight % the carrageenan is 0.35 weight % and when the water amounts to 90% the carrageenan amounts to about 0.1%.

4. A ready-to-eat low carbohydrate pudding according to claim 2 in which said pudding consisting essentially of:

| | |
|---|---|
| 80-90 | Water |
| 5-9 | Calcium Caseinate and/or Sodium Caseinate |
| 4.5-7.5 | Soy Protein Isolate |
| 0-3.0 | Whey Protein Isolate |
| 0-1.5 | Whey Protein Concentrate |
| 0.5-1.75 | Soybean Oil |
| 0.1-0.5 | Sodium Chloride |
| 0-0.4 | Potassium Chloride |
| 0.1-0.35 | Carrageenan |
| 0.1-0.45 | Dipotassium Phosphate |
| 0.1-0.5 | Flavor |
| 0.025-0.3 | Tricalcium Phosphate |
| 0.03-0.05 | Sucralose Powder |
| 0.03-0.04 | Acesulfame Potassium. |

5. A ready-to-eat low carbohydrate pudding according to claim 4 in which said pudding consisting essentially of:

| | |
|---|---|
| Water | 80.0000%-90.0000% |
| Calcium Caseinate | 5.000%-9.000% |
| Soy Protein Isolate | 4.5000%-7.5000% |
| Whey Protein Isolate | 0.0000%-3.0000% |
| Whey Protein Concentrate | 0.0000%-1.5000% |
| Soybean Oil | 0.5000%-1.5000% |
| Sodium Chloride | 0.1%-0.5000% |
| Potassium Chloride | 0.0%-0.4% |
| Carrageenan | 0.1000%-0.35000% |
| DiPotassium Phosphate | 0.1000%-0.1500% |
| Cocoa | 1.75000%-2.7500% |
| TriCalcium Phosphate | 0.02500%-0.3% |
| Sucralose Powder | 0.03%-0.0500% |
| Acesulfame Potassium | 0.0300%-0.0400%. |

6. A ready-to-eat low carbohydrate pudding according to claim 4 in which said pudding consisting essentially of:

| | |
|---|---|
| Water | 80.0000%-90.0000% |
| Calcium Caseinate | 6.0000%-9.0000% |
| Soy Protein Isolate | 4.5000%-7.5000% |
| Whey Protein Isolate | 0.0000%-3.0000% |
| Whey Protein Concentrate | 0.0000%-1.5000% |
| Soybean Oil | 0.7500%-1.7500% |
| Sodium Chloride | 0.1%-0.5000% |
| Potassium Chloride | 0.0%-0.4% |
| Carrageenan | 0.1000%-0.35000% |
| DiPotassium Phosphate | 0.3000%-0.4500% |
| Vanilla Flavor | 0.1000%-0.5000% |
| TriCalcium Phosphate | 0.0250%-0.3% |
| Sucralose Powder | 0.03%-0.0500% |
| Acesulfame Potassium | 0.0300%-0.0400%. |

7. A ready-to-eat low carbohydrate pudding according to claim 4 in which said pudding consisting essentially of:

| | |
|---|---|
| Water | 80.0000%-90.0000% |
| Calcium Caseinate | 6.0000%-9.0000% |
| Soy Protein Isolate | 4.5000%-7.5000% |
| Whey Protein Isolate | 0.0000%-3.0000% |
| Whey Protein Concentrate | 0.0000%-1.5000% |
| Soybean Oil | 0.7500%-1.7500% |
| Sodium Chloride | 0.1%-0.5000% |
| Potassium Chloride | 0.0%-0.4% |
| Carrageenan | 0.1000%-0.35000% |
| DiPotassium Phosphate | 0.3000%-0.4500% |
| Butterscotch Flavor | 0.1000%-0.5000% |
| TriCalcium Phosphate | 0.02500%-0.3% |
| Sucralose Powder | 0.03%-0.0500% |
| Acesulfame Potassium | 0.0300%-0.0400%. |

8. A ready-to-eat low carbohydrate pudding according to claim 4 in which said pudding consisting essentially of:

| | |
|---|---|
| Water | 80.0000%-90.0000% |
| Calcium Caseinate | 6.0000%-9.0000% |
| Soy Protein Isolate | 4.5000%-7.50000% |
| Whey Protein Isolate | 0.0000%-3.0000% |
| Whey Protein Concentrate | 0.0000%-1.5000% |
| Soybean Oil | 0.7500%-1.7500% |
| Sodium Chloride | 0.1%-0.5000% |
| Potassium Chloride | 0.0%-0.4% |
| Carrageenan | 0.1000%-0.35000% |
| DiPotassium Phosphate | 0.3000%-0.4500% |
| Banana Flavor | 0.1000%-0.5000% |
| TriCalcium Phosphate | 0.02500%-0.3% |
| Sucralose Powder | 0.03%-0.0500% |
| Acesulfame Potassium | 0.0300%-0.0400%. |

9. A ready-to-eat low carbohydrate pudding according to claim 4 in which said pudding consists of:

| | |
|---|---|
| Water | 83.7776% |
| Calcium Caseinate | 6.8714% |
| Soy Protein Isolate | 5.5556% |
| Soybean Oil | 0.5848% |
| Sodium Chloride | 0.4386% |
| Carrageenan | 0.3250% |
| DiPotassium Phosphate | 0.1170% |
| Cocoa | 2.2132% |
| TriCalcium Phosphate | 0.0439% |
| Sucralose Powder | 0.0400% |
| Acesulfame Potassium | 0.0330%. |

10. A ready-to-eat low carbohydrate pudding according to claim 4 in which said pudding consists of:

| | |
|---|---|
| Water | 84.7029% |
| Calcium Caseinate | 7.4562% |
| Soy Protein Isolate | 5.5556% |
| Soybean Oil | 0.8772% |
| Sodium Chloride | 0.4386% |
| Carrageenan | 0.3000% |
| DiPotassium Phosphate | 0.3626% |
| Vanilla Flavor | 0.1900% |
| TriCalcium Phosphate | 0.0439% |
| Sucralose Powder | 0.0400% |
| Acesulfame Potassium | 0.0330%. |

11. A ready-to-eat low carbohydrate pudding according to claim 4 in which said pudding consists of:

| | |
|---|---|
| Water | 84.2878% |
| Calcium Caseinate | 7.697% |
| Soy Protein Isolate | 5.7576% |
| Soybean Oil | 0.9091% |
| Sodium Chloride | 0.4545% |
| Carrageenan | 0.2% |
| DiPotassium Phosphate | 0.3758% |
| Flavor | 0.197% |
| TriCalcium Phosphate | 0.0455% |
| Sucralose | 0.0415% |
| Acesulfame Potassium | 0.0342% |

12. A ready-to-eat low carbohydrate pudding according to claim 4 in which said pudding consists of:

| | |
|---|---|
| Water | 83.3667% |
| Calcium Caseinate | 7.0909% |
| Soy Protein Isolate | 5.7576% |
| Soybean Oil | 0.6061% |
| Sodium Chloride | 0.4545% |
| Carrageenan | 0.15% |
| DiPotassium Phosphate | 0.1212% |
| Cocoa | 2.3318% |
| TriCalcium Phosphate | 0.0455% |
| Sucralose | 0.0415% |
| Acesulfame Potassium | 0.0342% |

13. A ready-to-eat low carbohydrate pudding according to claim 2 in which said pudding consisting essentially of:

| | |
|---|---|
| 80-90 | Water |
| 5-9 | Sodium Caseinate |
| 4.5-7.5 | Soy Protein Isolate |
| 0-3.0 | Whey Protein Isolate |
| 0-1.5 | Whey Protein Concentrate |
| 0.5-1.75 | Soybean Oil |
| 0.1-0.5 | Sodium Chloride |
| 0-0.4 | Potassium Chloride |
| 0.1-0.35 | Carrageenan |
| 0.1-0.45 | Dipotassium Phosphate |
| 0.1-0.5 | Flavor |
| 0.025-0.3 | Tricalcium Phosphate |
| 0.03-0.05 | Sucralose Powder |
| 0.03-0.04 | Acesulfame Potassium. |
